(19) United States
(12) Patent Application Publication
(10) Pub. No.: US 2010/0037164 A1
(43) Pub. Date: Feb. 11, 2010

(54) RECYCLING OF VIEW COMPONENTS IN A USER INTERFACE

(75) Inventors: Scott Morrison, Redmond, WA (US); Régis Lucien Francis Brid, Woodinville, WA (US); Yifung Lin, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/189,228

(22) Filed: Aug. 11, 2008

(51) Int. Cl. G06F 3/048

(52) U.S. Cl. 715/765

(57) ABSTRACT

Architecture that facilitates the recycling of view components (e.g., item controls, visual containers, etc.) in a user interface rather than recreating the view components when needed again in response to a view change such as a scrolling operation or other user navigation operation such as a paging control. In the context of a datagrid, the datagrid can now be more performant when scrolling through a large number of rows. The architecture includes a recycling component that recycles the visual containers by collecting the visual containers when rows are scrolled off the view, and reusing the visual containers with different data when rows are scrolled back into the view. Thus, all the containers stay the same—new data is simply applied to the recycled container.

### BACKGROUND

With the increasing demands placed on performance of computing systems vendors continue to seek ways in which to make these systems more efficient not only for productivity concerns but also for a positive user experience. This has particular application to the processing and presentation of information when dealing with large datasets.

A datagrid (or grid view) can be employed as a user interface to display a large number of data records such as millions of records of customer information, for example. Only a small number of the records (e.g., twenty) can be presented at any point in time. This is further based on the system on which the data will be presented. For example, a greater number of records can be displayed and interacted with on a desktop computer than on a handheld device such as a PDA which has limited viewing real estate.

Datagrid need to be performant when scrolling through a large number of rows, for example. Virtualization is a technique provided by a datagrid to only create a visual component for a small number of rows. Virtualization can be optimized as well. In some datagrids, only the visuals are drawn. Typically, datagrids optimize performance for large scale data usage by creating visuals or only drawing the components that are displayed at any given time, and deleting the visual when no longer needed, such as resulting from a scrolling operation that scrolls the visual off the viewing area. However, this is less than optimal as it impacts system performance as well as memory usage when the visual components need to be recreated or redrawn.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the recycling of view components (e.g., item controls, visual containers, etc.) in a user interface rather than recreating the view components when needed again in response to a view change such as a scrolling operation or other user navigation operation such as a paging control. This provides a significant improvement in performance, in processing time as well as memory usage.

In the context of a datagrid, the datagrid can now be more performant when scrolling through a large number of rows. The architecture includes a recycling component that recycles the visual containers by collecting the visual containers when rows are scrolled off the view, and reusing the visual containers with different data when rows are scrolled back into the view. Thus, all the containers stay the same—new data is simply applied to the recycled container.

To the accomplishment of the foregoing and related ends, certain illustrative aspects are described herein in connection with the following description and the annexed drawings. These aspects are indicative of the various ways in which the principles disclosed herein can be practiced, all aspects and equivalents of which are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented user interface system for recycling view controls.

FIG. 2 illustrates a computer-implemented user interface system that employs customization of item control characteristics in the presentation of item controls.

FIG. 3 illustrates a more specific computer-implemented user interface system that employs customization of visual container characteristics in a datagrid.

FIG. 4 illustrates a method of providing a user interface.

FIG. 5 illustrates a method of processing customized item control characteristics.

FIG. 6 illustrates an alternative method of processing customized item control characteristics.

FIG. 7 illustrates a block diagram of a computing system operable to execute item control user interface processing in accordance with the disclosed architecture.

### DETAILED DESCRIPTION

The disclosed architecture recycles view components such as item controls and visual containers, for example, in a user interface rather than recreating the view components when needed again. When a user scrolls a subset of the view components one or more of the components may scroll (or page) out of view. In response to this view change due to a user navigation operation, view components moved out of the view are collected in a store are simply reused based on a need for presenting more view components in the changing view. This provides a significant improvement in performance, in processing time as well as memory usage. For example, in one test, reuse of the view components yielded a 60% performance gain in terms of time and a 33% advantage in the amount of memory used.

To use the recycling mechanism and still maintain extensibility, end users can also customize view components before being displayed and “clean up” the customized view components before recycling.

In a specific instance, row recycling allows for the view components used to display the rows and columns of data to be reused as the user changes the view (e.g., scrolls, pages away from the view to another view). This ensures that only the visible portion of datagrid has view components created to display the datagrid, and those view components are recycled as the user scrolls. To do this, any time a row is scrolled off the screen, the row is set aside into a store for reusable rows, and then used for the next row scrolled onto the screen. In one implementation, a row that has been set aside can be reused right away since a row scrolled out can be immediately replaced by a row scrolled in. However, this is not a requirement, since there can be the case where a row scrolled off does not need to be replaced. Each time a row is scrolled onto the screen it is updated with the new data.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

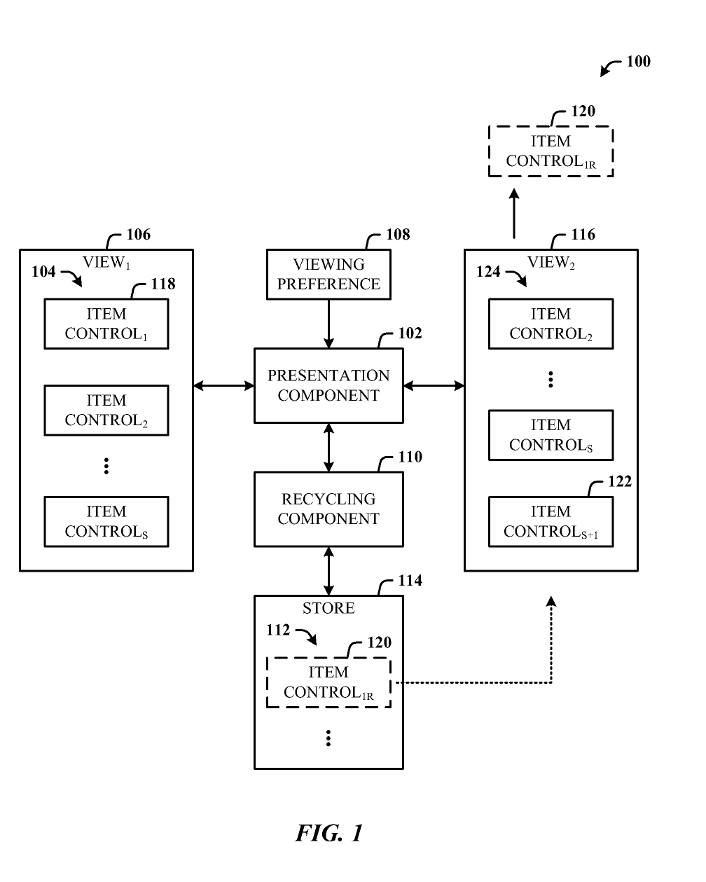

FIG. 1 illustrates a computer-implemented user interface system 100 for recycling view controls. The system 100 can include a presentation component 102 for presenting a subset of item controls 104 from a set of the item controls of a datastore (not shown) in an original view 106 (denoted View₁) based on a viewing preference 108 (e.g., scroll navigation operation, page control navigation operation, etc.). The system 100 can also include a recycling component 110 for storing reusable item controls 112 in a store 114 that are removed from an updated view 116 (denoted View₂) based on a change in the viewing preference 108. For example, a first item control 118 (denoted Item Control₁) in the original view 106 can be scrolled out of the original view 106, as represented now in association with the updated view 116 as the removed first item control 120 (denoted Item Control_{1R}) in a block with dashed border. When removed from the original view 106, the removed first item control 120 is depicted as stored in the store 114 for recycling (or reuse).

In other words, the first item control 118 can be removed from the original view 106 by scrolling downward such that the first item control 118 is no longer in the original view 106. Alternatively, the navigation operation can be a page control (e.g., keyboard strokes such as PageDown, PageUp, etc.) such that all visible rows (or all but a subset of the previously visible rows) are replaced by new rows.

The updated view 116 shows a new set of items controls 124 being presented, the new set of item controls 124 including, in this particular case where only one item control (the first item control 118 becomes the removed first item control 120) is scrolled out of view, the subset of item controls 104 (denoted Item Control₁, Item Control₂, . . . , Item Control_{S}) less the first item control 118, but now adding a new item control 122 at the bottom of the updated view 116, since the first item control 118 was scrolled out of presentation at the top of the updated view 116. The updated view 116 now includes the updated set of item controls 124 denoted as Item Control₂, . . . , Item Control_{S}, Item Control_{S+1}. This shows that a control (item control 122) different from the removed first item control 120 can be reintroduced at the bottom of the updated view 116. As previously indicated, however, it can be the case where the removed first item control 120 is then immediately reintroduced at the bottom of the updated view 116 in the place of the depicted new item control 122, rather than the new item control 122.

The recycling component 110 can provide one or more of the stored item controls 112 to the updated view 116 for re-presentation in response to a change in the viewing preference 108. In other words, the user can scroll upward or downward more than one item control such that multiple new item controls are appended to the bottom of the updated view 116 in a downward scroll navigation operation or appended to the top of the updated view 116 in an upward scroll navigation operation.

The item controls 104 can be visual containers employed for a datagrid, for example. The visual containers can be used to present rows and columns of data, and the visual containers can be stored in the store 114 and reused as the viewing preference 108, which is a user interface navigation operation, changes. In other words, the presentation component 102 and the recycling component 110 can be utilized as part of a datagrid for presenting visual containers.

The first item control 118 can be stored in association with the recycling component 110 when the change in the viewing preference 108 causes removal of an item control (e.g., item control 120) from the view (updated view 116). The presentation component 102 updates data associated with the added new item control 122 (the same as first item control 120 stored in the store 114) that is re-presented in the updated view 116, when the new item control 122 is presented in the updated view 116. The dotted line from the stored item control 120 to the updated view 116 indicates that the removed item control 120 is logically recycled out the updated view 116, into the store 114, and then back out of the store 114 to the updated view 116 based on the need for the new item control 122, which can be inserted at the top of the updated view 116 or at the bottom of the updated view 116.

In a more robust implementation, it is to be appreciated that item controls can be removed from the middle of the subset of item controls 104 such that new item controls can be inserted into the middle of the subset of item controls 104 as replacement rows, appended to the top or bottom of the subset of item controls 104, or processed using a combination of appends and middle insertions.

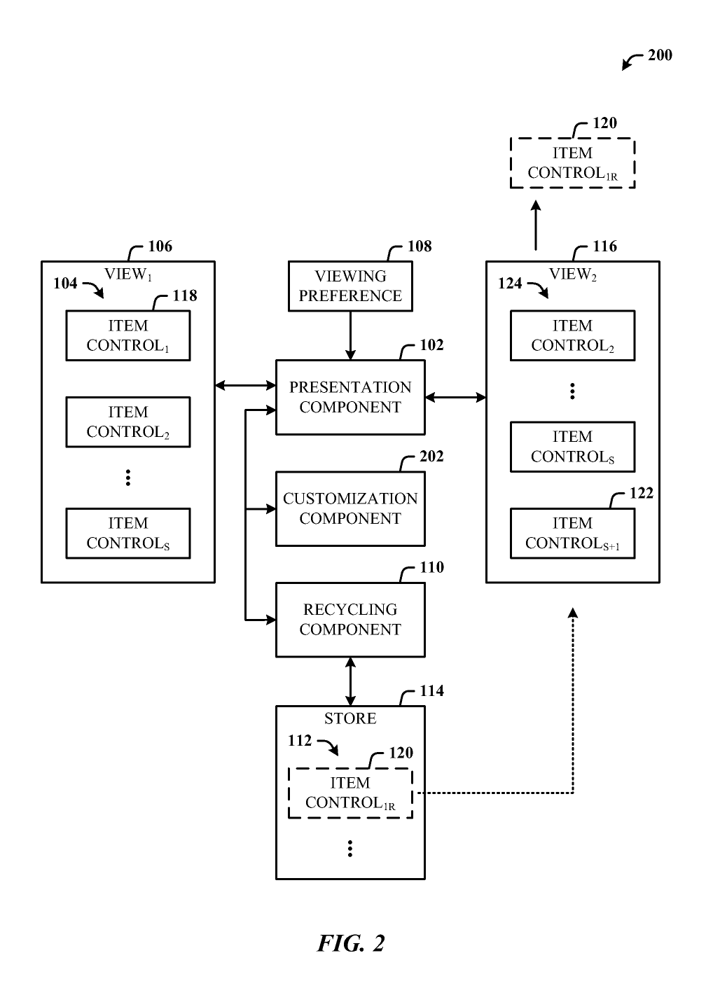

FIG. 2 illustrates a computer-implemented user interface system 200 that employs customization of item control characteristics in the presentation of item controls. The system 200 includes a customization component 202 in addition to system 100 of FIG. 1 for customizing characteristics of an item control. For example, where the item controls are visual containers, reusing the visual containers for rows can cause customers to run into issues when modifying the characteristics of certain rows. For example, if a user sets the height of a row to a unique value, this unique value will show for a different row when the visual container is reused, causing unpredictable behavior. One technique for avoiding this issue is to not expose the visual container for rows and encourage the users to achieve unique characteristics through data binding of the unique values to the underlying data or through visual states. Alternatively, to provide extensibility in the disclosed architecture, the customization component 202 provides a mechanism for the user to set unique characteristics to an item control, and then cleanup these unique item controls and/or characteristics through a loading event and an unloading event.

Following is sample code for a datagrid interface that can be employed for loading and unloading events.

```
public event EventHandler<DataGridRowEventArgs> LoadingRow;
public event EventHandler<DataGridRowEventArgs> UnloadingRow;
public class DataGridRowEventArgs : EventArgs
{
    public DataGridRowEventArgs(DataGridRow dataGridRow)
    {
        if (dataGridRow == null)
        {
            throw new
            ArgumentNullException(“dataGridRow”);
        }
        this.Row = dataGridRow;
    }
    public DataGridRow Row
    {
        get;
        private set;
    }
}
```

Following is sample code that can utilize the above interface to modify the height of a specific row.

```
// Developer listens to the LoadingRow event to set a unique Height
dataGrid. LoadingRow +=
    new EventHandler<DataGridRowEventArgs>(DataGrid_{—}
    LoadingRow);
// Developer listens to the UnloadingRow to revert the unique height
so the row can be reused
dataGrid. UnloadingRow +=
    new EventHandler<DataGridRowEventArgs>(DataGrid_{—}
    UnloadingRow);
private void DataGrid_{—} LoadingRow (object sender,
DataGridRowEventArgs e)
{
    // Unique Height is set in LoadingRow event handler
    e.Row.Height = 65;
}
private void DataGrid_UnloadingRow (object sender,
DataGridRowEventArgs e)
{
    // Old Height is set so the row can be reused
    e.Row.Height = oldHeight;
}
```

This last set of code indicates that reversion can be obtained after the unique item control has been presented and then removed. This further obviates the need to create a new item control, thereby providing improved performance and memory management.

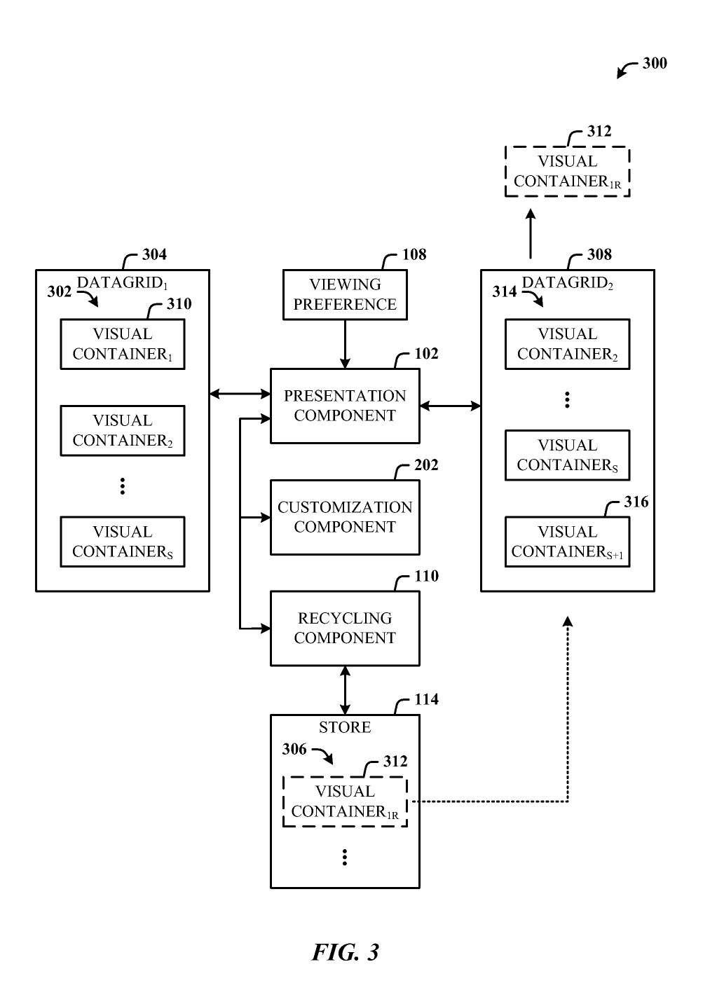

FIG. 3 illustrates a more specific computer-implemented user interface system 300 that employs customization of visual container characteristics in a datagrid. The system 300 includes the presentation component 102 for presenting a subset of visual containers 302 from a set of the visual containers of a datastore (not shown) in an original datagrid 304 (denoted Datagrid₁) based on the viewing preference 108 (e.g., scroll navigation operation, page control navigation operation, etc.). The system 300 can also include the recycling component 110 for storing reusable visual containers 306 in the store 114 (e.g., datastore) that are removed from an updated datagrid 308 (denoted Datagrid₂) based on a change in the viewing preference 108. For example, a first visual container 310 (denoted Visual Container₁) in the original datagrid 304 can be scrolled out of the original datagrid 304, as represented now in association with the updated datagrid 308 as the removed first visual container 312 (denoted Visual Container_{1R}) in a block with dashed border. When removed from the original datagrid 304, the removed first visual container 312 is depicted as stored in the store 114 for recycling (or reuse).

In other words, the first visual container 310 can be removed from the original datagrid 304 by scrolling downward such that the first visual container 310 is no longer in the original datagrid 304. Alternatively, the navigation operation (viewing preference 108) can be a page control such that the first visual container 310 is no longer being presented.

The updated datagrid 308 shows a new set of visual containers 314 being presented, the new set of visual containers 314 including, in this particular case where only one visual container (the first visual container 310) becomes the removed first visual container 312) is moved out of view, the subset of visual containers 302 (denoted Visual Container₁, Visual Container₂, . . . , Visual Container_{S}) less the first visual container 310, but now adding a new visual container 316 at the bottom of the updated datagrid 308, since the first visual container 310 was scrolled out of presentation at the top of the updated datagrid 308. The updated datagrid 308 now includes the updated set of item controls 314 denoted as Visual Container₂, . . . , Visual Container_{S}, Visual Container_{S+1}.

The recycling component 110 can provide one or more of the stored visual containers 306 to the updated datagrid 308 for re-presentation in response to a change in the viewing preference 108. In other words, the user can scroll upward or downward more than one item control such that multiple new item controls are appended to the bottom of the updated datagrid 308 in a downward scroll navigation operation or appended to the top of the updated datagrid 308 in an upward scroll navigation operation.

The visual containers can be used to present rows and columns of data, and the visual containers can be stored in the store 114 and reused as the viewing preference 108, which is a user interface navigation operation, changes. In other words, the presentation component 102 and the recycling component 110 can be utilized as part of a datagrid for presenting the visual containers.

The first visual container 310 can be stored in association with the recycling component 110 (in the store 114) when the change in the viewing preference 108 causes removal of a visual container (e.g., visual container 312) from the view (updated datagrid 308). The presentation component 102 updates data associated with the added new visual container 316 (the same as first visual container 312 stored in the store 114) that is re-presented in the updated datagrid 308, when the new visual container 316 is presented in the updated datagrid 308. The dotted line from the stored visual container 312 to the updated datagrid 308 indicates that the removed visual container 312 is logically recycled out the original datagrid 304, into the store 114, and then back out of the store 114 to the updated datagrid 308 based on the need for the new visual container 312, which can be inserted at the top of the updated datagrid 308 or at the bottom of the updated datagrid 308, for example.

In a more robust implementation, it is to be appreciated that visual containers can be removed from the middle of the subset of visual containers 304 such that new visual containers can be inserted into the middle of the subset of visual containers 302 as replacement rows, appended to the top or bottom of the subset of visual containers 302, or processed using a combination of appends and middle insertions. The system 300 can also include the customization component 202 for customizing characteristics of a visual container. The customization component 202 also provides the mechanism for the user to set unique characteristics to visual containers, and then cleanup these unique visual containers and/or characteristics through the loading and unloading events.

In other words, system 300 is a computer-implemented user interface system that comprises the presentation component 102 for presenting the subset of visual containers 302 in the datagrid 304 based on the viewing preference 108, and the recycling component 110 for storing visual containers 306 removed from presentation in the original datagrid 304 and providing a stored visual container (e.g., visual container 312) to the presentation component 102 for re-presentation in response to a change in the viewing preference 108.

The visual containers are associated with rows of data in the original datagrid 304 and updated datagrid 308. The visual containers 306 are stored and reused as the viewing preference 108 is changed according to user navigation operations.

The presentation component 102 removes a visual container from view at a top of the presentation based on a scrolling operation and recycles the removed visual container into the view at a bottom of the presentation. Conversely, the presentation component 102 can remove a visual container from view at a bottom of the presentation based on a scrolling operation and recycles the removed visual container into view at a top of the presentation.

The subset of visual containers can define a visual tree of visual containers currently being presented and of the stored visual containers. The recycling component 110 recycles the visual containers via the visual tree. The customization component 202 is provided for customizing a visual container with custom characteristics and managing the custom visual container during loading of the custom visual container for presentation and unloading of the custom visual container from the presentation.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

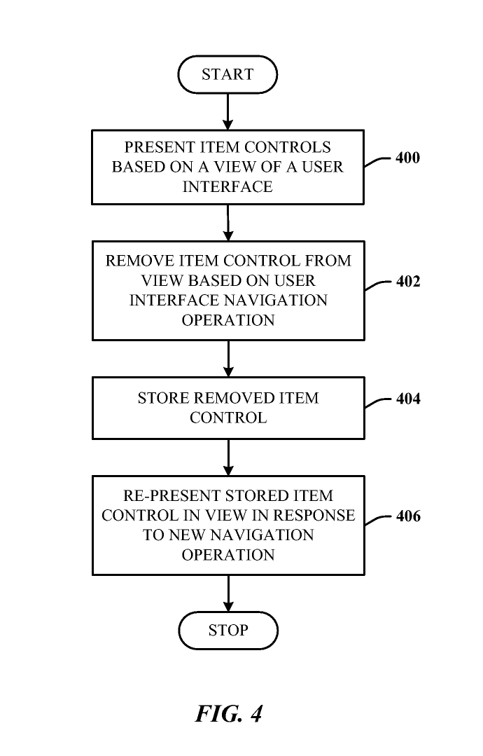

FIG. 4 illustrates a method of providing a user interface. At 400, item controls are presented based on a view of the user interface. At 402, an item control is removed from the view based on a user interface navigation operation. At 404, the removed item control is stored. At 406, the stored item control is re-presented in the view in response to a new navigation operation.

The item controls can be of different dimensions and the acts of removing, storing, and re-presenting are automatically repeated in response to a scrolling navigation operation. The method can further comprise updating data associated with the stored item control when re-presenting the stored item control. The item controls can be visual containers associated with rows of data of a datagrid. The method can further comprise repeating the acts of removing, storing, and re-presenting the item control based on scrolling operations and paging controls.

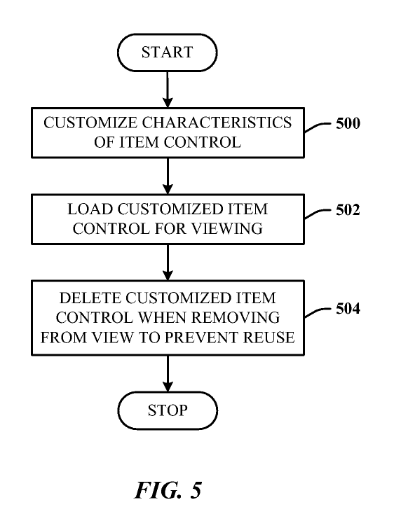

FIG. 5 illustrates a method of processing customized item control characteristics. At 500, an item control is customized with custom characteristics. At 502, the customized item control is loaded for viewing. At 504, the customized item control is deleted when removed from view to prevent reuse.

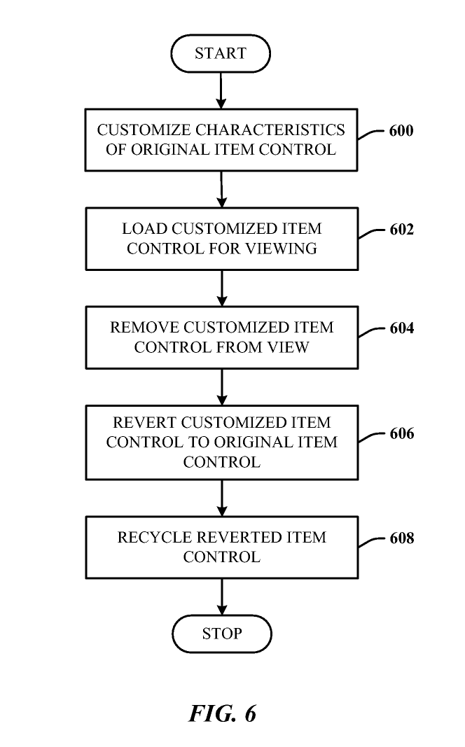

FIG. 6 illustrates an alternative method of processing customized item control characteristics. At 600, an original item control is customized with custom characteristics. At 602, the customized item control is loaded for viewing. At 604, the customized item control is removed from the view. At 606, the customized item control is reverted to the original item control. At 608, the reverted original item control is recycled.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

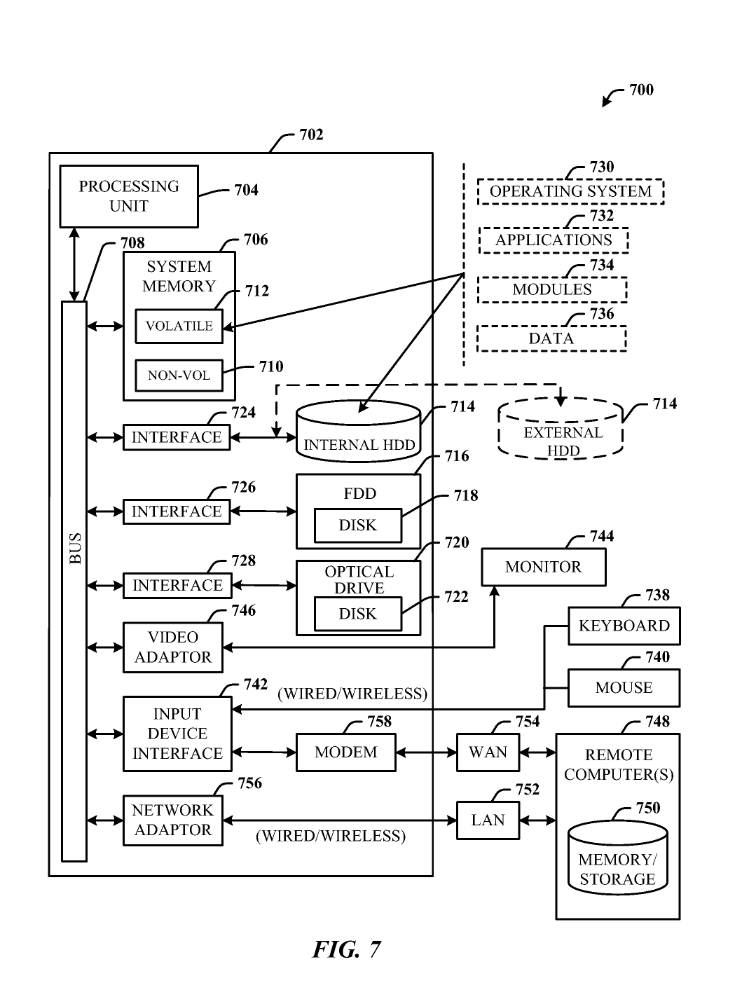

Referring now to FIG. 7, there is illustrated a block diagram of a computing system 700 operable to execute item control user interface processing in accordance with the disclosed architecture. In order to provide additional context for various aspects thereof, FIG. 7 and the following discussion are intended to provide a brief, general description of a suitable computing system 700 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 7, the exemplary computing system 700 for implementing various aspects includes a computer 702 having a processing unit 704, a system memory 706 and a system bus 708. The system bus 708 provides an interface for system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 can include non-volatile memory (NON-VOL) 710 and/or volatile memory 712 (e.g., random access memory (RAM)). A basic input/output system (BIOS) can be stored in the non-volatile memory 710 (e.g., ROM, EPROM, EEPROM, etc.), which BIOS are the basic routines that help to transfer information between elements within the computer 702, such as during start-up. The volatile memory 712 can also include a high-speed RAM such as static RAM for caching data.

The computer 702 further includes an internal hard disk drive (HDD) 714 (e.g., EIDE, SATA), which internal HDD 714 may also be configured for external use in a suitable chassis, a magnetic floppy disk drive (FDD) 716, (e.g., to read from or write to a removable diskette 718) and an optical disk drive 720, (e.g., reading a CD-ROM disk 722 or, to read from or write to other high capacity optical media such as a DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 712, including an operating system 730, one or more application programs 732, other program modules 734, and program data 736. The one or more application programs 732, other program modules 734, and program data 736 can include the presentation component 102, recycling component 110, store 114, views (106 and 116) and item controls of FIG. 1, the customization component 202 of FIG. 2, the system 300 of FIG. 3 and visual containers, and the methods associated with FIGS. 4-6, for example.

All or portions of the operating system, applications, modules, and/or data can also be cached in the volatile memory 712. It is to be appreciated that the disclosed architecture can be implemented with various commercially available operating systems or combinations of operating systems.

A user can enter commands and information into the computer 702 through one or more wire/wireless input devices, for example, a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, etc.

A monitor 744 or other type of display device is also connected to the system bus 708 via an interface, such as a video adaptor 746. In addition to the monitor 744, a computer typically includes other peripheral output devices (not shown), such as speakers, printers, etc.

The computer 702 may operate in a networked environment using logical connections via wire and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, is connected to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented user interface system, comprising:
a presentation component for presenting a subset of item controls from a set of the item controls in a view based on a viewing preference; and
a recycling component for storing item controls removed from the view based on a change in the viewing preference and providing one or more of the stored item controls to the view for re-presentation in response to a change in the viewing preference.

2. The system of claim 1, wherein the item controls are visual containers.

3. The system of claim 2, wherein the visual containers are used to present rows and columns of data, the visual containers stored and reused as the viewing preference, which is a user interface navigation operation, changes.

4. The system of claim 1, wherein the presentation component and the recycling component are utilized as part of a datagrid for presenting visual containers.

5. The system of claim 1, wherein the item control is stored in association with the recycling component when a change in the viewing preference causes removal of an item control from the view.

6. The system of claim 1, wherein the presentation component updates data associated with an item control that is re-presented from the recycling component.

7. The system of claim 1, further comprising a customization component for customizing an item control with custom characteristics and managing the custom item control during loading and unloading events to the presentation component.

8. A computer-implemented user interface system, comprising:
a presentation component for presenting a subset of visual containers in a datagrid based on a viewing preference; and
a recycling component for storing visual containers removed from presentation and providing a stored visual container to the presentation component for re-presentation in response to a change in the viewing preference.

9. The system of claim 8, wherein the visual containers are associated with rows of data in the datagrid, the visual containers stored and reused as the viewing preference is changed according to user navigation operations.

10. The system of claim 8, wherein the presentation component removes a visual container from view at a top of the presentation based on a scrolling operation and recycles the removed visual container into the view at a bottom of the presentation.

11. The system of claim 8, wherein the presentation component removes a visual container from view at a bottom of the presentation based on a scrolling operation and recycles the removed visual container into view at a top of the presentation.

12. The system of claim 8, wherein the subset of visual containers defines a visual tree of visual containers currently being presented and of the stored visual containers, the recycling component recycling the visual containers via the visual tree.

13. The system of claim 8, further comprising a customization component for customizing a visual container with custom characteristics and managing the custom visual container during loading of the custom visual container for presentation and unloading of the custom visual container from the presentation.

14. A computer-implemented method of providing a user interface, the method comprising acts of:
presenting item controls based on a view of the user interface;
removing an item control from the view based on a user interface navigation operation;
storing the removed item control; and
re-presenting the stored item control in the view in response to a new navigation operation.

15. The method of claim 14, wherein the item controls are of different dimensions and the acts of removing, storing, and re-presenting are automatically repeated in response to a scrolling navigation operation.

16. The method of claim 14, further comprising updating data associated with the stored item control when re-presenting the stored item control.

17. The method of claim 14, further comprising acts of:
customizing an item control with custom characteristics;
loading the customized item control for viewing; and
deleting the customized item control when removing the customized item control from the view to prevent reuse.

18. The method of claim 14, wherein the item controls are visual containers associated with rows of data of a datagrid.

19. The method of claim 14, further comprising repeating the acts of removing, storing, and re-presenting the item control based on scrolling operations and paging controls.

20. The method of claim 14, further comprising setting unique characteristics to an original item control to create a unique item control and reverting the unique item control to the original item control when the unique item control is removed from the view.
